(19) United States
(12) Patent Application Publication
(10) Pub. No.: US 2012/0169480 A1
(43) Pub. Date: Jul. 5, 2012

(54) METHOD AND APPARATUS FOR INFORMATION STORING

(75) Inventors: Joni Jantunen, Helsinki (FI); Sergey Boldyrev, Soderkulla (FI); Jarmo Arponen, Espoo (FI)

(73) Assignee: NOKIA CORPORATION, Espoo (FI)

(21) Appl. No.: 13/395,669

(22) PCT Filed: Nov. 11, 2009
(86) PCT No.: PCT/IB2009/055006

§ 371 Date: Mar. 13, 2012

(51) Int. Cl. G06K 7/01

(52) U.S. Cl. 340/10.51

(57) ABSTRACT

In accordance with an example embodiment of the present invention, an apparatus, a computer program product and a method is provided for detecting a write-enabled device via a short-range communications interface, selecting an operation mode for writing data to a memory associated with the write-enabled device and writing data to the memory associated with the write-enabled device according to the selected operation mode.

### TECHNICAL FIELD

The present application relates generally to wireless communication and information storing.

### BACKGROUND

Modern society has adopted, and is becoming reliant upon, electronic devices for various purposes, such as, storing information. Electronic devices can vary from battery powered handheld devices to stationary household and/or commercial devices utilizing an electrical network as a power source. Due to rapid development of the electronic devices a number of areas capable of enabling entirely new types of practical applications have emerged. Not only has the processing power of electronic devices become faster and more power efficient than before, but also the memories and radio communication interfaces have developed with leaps such that new opportunities for useful implementations arise with an increasing pace.

Radio Frequency Identification (RFID) is an example of a technology that is experiencing a change of generation thanks to development in both communications and memory technologies. Originally, RFID was intended to provide an inexpensive, remotely readable tag that basically functions as a remotely readable bar code with a small memory to hold for example the identity of the tag. The tag comprised a small persistent memory with a unique identity (ID) corresponding to a code represented by the bar code system. For remote reading, a wireless transponder was provided to send the ID when receiving suitable radio transmission powering the transponder. Recently, faster radio powered communication technologies have been developed and the development of new memories enable storing of more than just some bytes of data in a memory associated with an RFID tag.

The Micro-Nano integrated platform for transverse Ambient Intelligence applications, (MINAmI) Project, Supported by the European Commission through the Sixth Framework Programme for Research and Development, addresses Ambient Intelligence (AmI) applications, where an electronic device, such as a personal mobile device may act as a gateway. With the MINAmI Ambient Intelligence system, the physical environment can be loaded with interesting and context related information, easily and naturally accessible to the user. Information may be stored in radio frequency tags and sensors embedded in physical surroundings and everyday objects, and it can be anything from sensor measurements from the environment to a piece of music or the latest news. The user of the personal mobile device can wirelessly access this information content by just touching or scanning close to the radio frequency tags and/or sensors with the personal mobile device capable of machine reading the information content. The personal mobile device, such as a mobile phone may also enable wireless connection to the internet. As the interaction can be tied to a specific place, object, and time, the user may be served with context related information and services. The MINAmI Project is intended to define a communication protocol/system for providing high data rate communication between a reader/writer device and large memory containing radio frequency tags operating over a high data rate communication channel.

### SUMMARY

Various aspects of examples of the invention are set out in the claims.

According to a first aspect of the present invention, a method is provided comprising detecting a write-enabled radio frequency tag. The method further comprising selecting an operation mode comprising a protocol configured to write data to the write-enabled radio frequency tag, and transmitting data to the memory associated with the write-enabled radio frequency tag according to the selected operation mode.

According to a second aspect of the present invention, a computer program product is disclosed, adapted to cause performation of the method according to the first aspect when said program is run on a computer.

According to a third aspect of the present invention, an apparatus is disclosed, comprising means for detecting a write-enabled radio frequency tag, means for selecting an operation mode comprising a protocol configured to write data to the write-enabled radio frequency tag and means for transmitting data to the memory associated with the write-enabled radio frequency tag according to the selected operation mode.

According to a fourth aspect of the present invention, a method is provided comprising receiving a wireless communication signal, the wireless signal comprising data and a protocol configured to write data into a write-enabled device according to an operation mode. The method further comprising storing the received data in an associated memory, wherein the associated memory comprises at least two memory sections, wherein the operation mode data determines a memory section of the at least two memory sections to which the received data is stored.

According to a fifth aspect of the present invention, a computer program product is disclosed, adapted to cause performation of the method according to the fourth aspect when said program is run on a computer.

According to a sixth aspect of the present invention, an apparatus is disclosed, comprising means for receiving a wireless signal, the wireless signal comprising data and a protocol configured to write the data into a write-enabled device according to an operation mode, wherein the associated memory comprises at least two memory sections, wherein the operation mode determines a memory section of the at least two memory sections to which the received data is stored.

According to a seventh aspect of the present invention, an apparatus is disclosed, comprising a short-range communications module configured to detect a write-enabled device and a processor configured to select an operation mode comprising a protocol configured to write data to the write-enabled device, wherein the short-range communications module is further configured to transmit data to the write-enabled device according to the selected operation mode.

According to an eight aspect of the present invention, an apparatus is disclosed, comprising a short-range communications module configured to receive a wireless signal, the wireless signal comprising data and a protocol configured to write the data into a write-enabled device according to an operation mode indication associated with the data. The apparatus further comprising a memory configured to store the received data, the memory comprising at least two memory sections, wherein the operation mode determines a memory section of the at least two memory sections to which the data received data is stored.

### BRIEF DESCRIPTION OF THE DRAWINGS

For a more complete understanding of example embodiments of the present invention, reference is now made to the following descriptions taken in connection with the accompanying drawings in which:

FIG. 1 discloses an example of operational environment in which apparatuses according to an example embodiment of the invention may be used;

FIG. 2 discloses a modular layout for an example apparatus according to an example embodiment of the present invention;

FIG. 3 discloses a modular layout of a device, such as a write-enabled radio frequency tag device according to an example embodiment on the present invention;

FIG. 4 illustrates a flow diagram showing operations for information storing according to an example embodiment of the present invention;

FIG. 5 illustrates a flow diagram showing operations for information storing according to an example embodiment of the present invention; and

FIG. 6 discloses an apparatus comprising example hardware for implementing computer software instructions stored in the apparatus according to an example embodiment of the present invention.

### DETAILED DESCRIPTION OF THE DRAWINGS

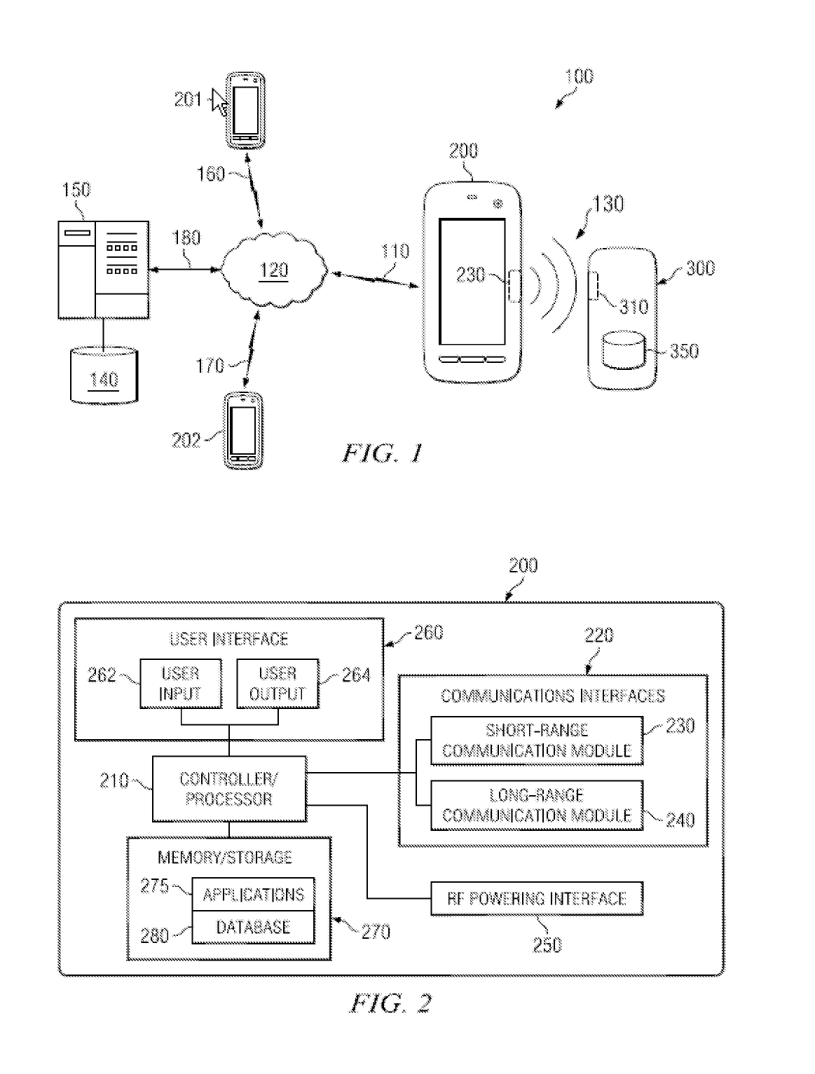

An example embodiment of the present invention and its potential effects are understood by referring to FIGS. 1 through 6 of the drawings.

FIG. 1 discloses an example of operational environment 100 in which various apparatuses according to an example embodiment of the invention may be used. An apparatus 200, for example a personal computer, an engineering workstation, a personal digital assistant, a portable computer, a computerized watch, a wired or wireless terminal, phone, node, and/or the like, a set-top box, a personal video recorder (PVR), an automatic teller machine (ATM), a game console, or the like is shown having communication means, such as a short-range communications interface 230, configured to communicate wirelessly with various short-range communication devices, such as a write-enabled radio frequency tag device 300 over a short-range communications link 130. The apparatus 200 may further be embodied as a portable wireless communications device equipped with means to communicate with network 120 via a wireless communication link 110 as illustrated in FIG. 1.

Depending on the embodiment, the wireless communication link 110 may be provided over a short-range communication connection or a wide-area communication connection. Short-range communication connections may be used for the exchange of information over a local area varying for example from a couple of meters to some hundred of meters. Examples of wireless short-range communication technologies comprise Bluetooth™, WLAN, wireless universal serial bus (WUSB), ultra-wideband (UWB), ZigBee (802.15.4, 802.15.4a), and ultra high frequency radio-frequency identification (UHF RFID) technologies. Examples of wireless wide-area communication technologies comprise 2^{nd} generation (2G) digital cellular networks, for example Global System for Mobile Communications (GSM) that may communicate in the 900 MHz/1.8 GHz bands in Europe and in the 850 MHz and 1.9 GHz bands in the United States. Wide-area communication technologies may further comprise general packet radio service (GPRS) technology, universal mobile telecommunications system (UMTS) technology, code division multiple access (CDMA) technologies, and/or the like.

According to an alternative example embodiment, the link 110 may be provided with a wired connection. Examples of wired communication technologies include ethernet, IEEE 1394, universal serial bus (USB) protocol, any other serial or parallel wired connection, and/or the like. Network 120 may be either a wireless network, or a wired network. Network 120 may further be connected to other networks. According to a further example embodiment, apparatus 200 may be a stationary device having a wireless and/or a wired interface for communicating with network 120.

As further shown in FIG. 1 various other devices, such as other mobile devices 201, 202 and server 150 including a database 140 may be connected to the network 120 via respective links (160, 170 and 180) so that apparatus 200 may communicate with any of the other devices via the network 120.

According to one example embodiment of the present invention, the apparatus 200, such as a portable reader/writer device, may transmit RF power to the write-enabled radio frequency tag device 300 for providing the necessary power for the write-enabled radio frequency tag device 300 to operate and/or communicate. The apparatus 200 may include an ultra-high frequency (UHF) power transceiver configured to transmit RF power to the write-enabled radio frequency tag device 300. Alternatively, necessary RF power for tag operation may be included in interrogation signals transmitted by the apparatus 200 for detecting radio frequency enabled devices as shown in the example embodiment of FIG. 1. The write-enabled radio frequency tag device 300, upon being energized and receiving the interrogation signal with an associated RF interface 310, may transmit a response signal to the apparatus 200. The response signal may include information, such as information relating to the capabilities of the responding device. According to an example embodiment, the information included in the response signal includes indication that the responding device is a tag device that is write-enabled, i.e. capable of storing data provided to the responding device, namely the write-enabled radio frequency tag device 300.

Apparatus 200 may use the received response signal for detecting presence of the write-enabled radio frequency tag device 300. After detection of the write-enabled radio frequency tag device 300 by the apparatus 200 embodied for example as a reader/writer device in accordance with FIG. 1, the devices may negotiate operation mode to write data into the write-enabled radio frequency tag device 300. Irrespectively, apparatus 200 selects an operation mode comprising a protocol configured to write data to the write-enabled radio frequency tag device 300 and transmits data to the write-enabled radio frequency tag device 300 according to the selected operation mode. According to one embodiment, the protocol configured to write data to the write-enabled radio frequency tag device 300 may comprise an indication corresponding to the selected operation mode.

The write-enabled radio frequency tag device 300, after receiving the data transmitted by the apparatus 200, may store the data to an associated memory 350 in accordance with the operation mode indication provided by the apparatus 200.

FIG. 2 discloses a modular layout for an example apparatus according to an example embodiment of the present invention. In FIG. 2, apparatus 200 is broken down into modules configured to cause the apparatus to perform various functionalities. The functionalities may be provided by various combinations of the software and/or hardware components discussed below according to an embodiment of the present invention.

Control module 210 is configured to regulate operation of the apparatus 200. The control module may be embodied as a controlling means, for example as a controlling circuitry or a processor. Inputs for the control module 210 may be received from various other modules comprised within apparatus 200. For example, user interface 260 may provide input to the control module 210 in response to receiving input from a user via user input 262. So, user input received via the user interface 260 may be used as an input in the control module 210 for controlling the operation of the apparatus 200. Control module 210 may interpret and/or process the input data and, in response, may issue one or more control commands to at least one of the other modules in apparatus 200.

In accordance with an example embodiment, apparatus 200, such as an electronic device, comprises communications interfaces 220. Communications interfaces 220 may incorporate one or more communication modules of the apparatus 200. In an example embodiment, the communications interfaces 220 may comprise means for wired and/or wireless communication. As shown in the example of FIG. 2, communications interfaces 220 may comprise a short-range communications module 230 and a long-range communications module 240. It should be understood that although FIG. 2 illustrates only one short-range communication module 230 and one long-range communication module 240 for the sake of clarity, apparatus 200 may comprise any number of further communications modules. For example, two or more additional wired and/or wireless communication modules may be included in the apparatus 200. Apparatus 200 utilizes one or more of these modules to receive information from both local and long distance sources, and to transmit data to recipient devices from apparatus 200. Communications interfaces 220 may be activated by control module 210, or by control resources local to the sub-modules responding to received messages, environmental influences and/or other devices in communication with the apparatus 200.

Short-range communication module 230 may comprise a radio-frequency identification (RFID) module embodied as RFID reader/writer. RFID technologies comprise a range of RF transmission systems, for example standardized and proprietary systems for a large number of different purposes, such as product tagging for inventory handling and logistics, theft prevention purposes at the point of sales and product recycling at the end of the life-cycle of the tagged product. In addition, RFID systems have been introduced for various payment and ticketing concepts comprising public transportation ticketing and payment. As an example, in several European countries and also in Canada and Mexico, there are several public transportation systems based on Calypso, the international electronic ticketing standard for microprocessor contactless smartcards, originally designed by a group of European transit operators. Further, for example in Japan, Hong Kong and Korea, there are Felicity Card (FeliCa) technology based mass transit systems, such as the Octopus card system in Hong Kong. The Octopus card is a rechargeable contactless stored value smart card used to transfer electronic payments in online or offline systems in Hong Kong.

As a subset of RFID technologies, Near Field Communication (NFC) technology that has evolved from a combination of existing contactless identification and interconnection technologies. NFC is both a “read” and “write” technology. Communication between two NFC-compatible devices occurs when they are brought within close proximity of each other: a simple wave or touch can establish an NFC connection, which is then compatible with other known wireless technologies, such as Bluetooth™ or wireless local area network (WLAN). NFC can be used with a variety of devices, from mobile phones that enable payment or transfer information to digital cameras that send their photos to a TV set with just a touch to name a few examples.

As the RFID technologies are becoming more prevalent, there already exists a large amount of RFID based applications, for example transportation tickets, animal and/or human implantations for tracking and other purposes, and the like. Radio-Frequency Identification (RFID) technologies provide wireless systems for automatic identification, tracking and managing of objects via a wireless connection between a tag attached to the object and a reader device, such as apparatus 200. The tag, such as write-enabled radio frequency tag of FIG. 1, may include a transponder that may be active or passive. In the presence of an electromagnetic field created by the reader device, the transponder may transmit at least an object identity signal. The reader device may sense and decode the broadcast signal to identify the object. The object identity is received by the reader device via a connectionless communication. In other words, the object identity signal may be received without a logical connection between the reader device and the tag attached to the object.

Short-range communication module 230 may also comprise short-range communication interface embodied for example as a transmitter and/or receiver for exchanging information across short-range wireless network using a short-range communication protocol. Example communication protocols for short-range communication may comprise Bluetooth™, Bluetooth™ Low Energy (Bluetooth LE), wireless local area network (WLAN), ultra-wide band (UWB), and wireless universal serial bus (WUSB) technologies.

Long-range communication module 240 may comprise a long-range communications interface configured to communicate and exchange information over a long distance in a large geographic area using any of the wide-area communication technologies described earlier. Examples of wireless long-range communication technologies comprise 2^{nd} generation (2G) digital cellular networks, for example Global System for Mobile Communications (GSM) that may communicate in the 900 MHz/1.8 GHz bands in Europe and in the 850 MHz and 1.9 GHz bands in the United States. Long-range communication technologies may further comprise general packet radio service (GPRS) technology, universal mobile telecommunications system (UMTS) technology, code division multiple access (CDMA) technologies, and/or the like. Long-range communication technologies may also operate to transmit and receive messages, such as text messages via a short messaging service (SMS), and/or multimedia content via multimedia messaging service (MMS) messages. Long-range communication technologies may provide voice and data services.

As a subset of long-range communications module 240, or alternatively operating as an independent module separately coupled to processor 210, the apparatus 200 may comprise a broadcast receiver. The broadcast receiver may be a digital audio- or video receiver, for example a digital audio broadcasting (DAB) or a digital video broadcasting (DVB) receiver, and/or the like. According to an example embodiment, the broadcast receiver comprises a Digital Video Broadcast for Handheld Apparatuses (DVB-H) receiver. The broadcasting transmissions may be encoded so that only certain apparatuses may access the transmitted content. The broadcast transmission may comprise text, audio and/or video information, and data. In an example embodiment, apparatus 200 may receive broadcasts and/or information within the broadcast signal to determine if the apparatus is permitted to view the received content.

According to one example embodiment either the short-range communications module 230, or the long-range communications module 240 may be equipped with a wired interface that may be used for communicating with another device using a wired communication protocol via an interface such as Ethernet, an IEEE 1394 communication interface, a universal serial bus (USB) interface, and/or the like.

According to one embodiment, apparatus 200 may further comprise an RF powering interface 250. RF powering interface 250 may be configured to provide a wireless signal for enabling a write-enabled device, such as the write-enabled radio frequency tag device 300 of FIG. 1 to receive necessary power for operation. RF powering interface 250 may be further configured to provide an RF field for enabling the write-enabled device, such as the write-enabled radio frequency tag device 300, to receive necessary power for responding to signals transmitted by the apparatus via the short-range communication module 230. An example of such RF powering interface 250 is an ultra-high frequency (UHF) power transceiver that has the sole purpose of creating a powering signal when apparatus 200 is communicating with a tag device requiring such external powering. This type of powering interface may be advantageous especially in situations where the apparatus 200 is communicating with radio frequency tags operating over a high data rate communication channel, such as an impulse radio based UWB short-range communication protocol that is not capable of providing the necessary power to the passive and/or semi-passive tag device with the transmitted communication signals. Alternatively, the RF powering interface 250 may be implemented within one or more of the communication modules. As an example, the RF powering interface 250 may be included within the long-range communication module 240 implemented for example as an add-on part of the Global System for Mobile Communications (GSM) radio module that is used to alter the communication modules behavior to provide the necessary RF powering signal when such powering is needed. Similarly, the RF powering interface 250 may be included within the short-range communication module 230 implemented for example as an add-on part of the RFID communications module alter the communication modules behavior to provide the necessary RF powering signal when such powering is needed.

User interface 260 may include visual, audible and/or tactile elements which allow a user to receive data from, and enter data into, the apparatus. Data entered by a user is received via user input module 262 and may be interpreted by control module 210, for example to affect the behavior of apparatus 200. User-inputted data may also be transmitted via any of the communication modules of the communications interfaces 220 to another device. Information may also be received by other devices at the apparatus 200 via communications interfaces 220. Control module 210 may cause this information to be transferred to user interface 260 for presentation to the user via user output module 264. User interface 220 may comprise one or more user input and output modules, and there may also be a module operating both as a user input module 262 and user output module 264, for example a touch screen display operating as a tactile user interface.

Apparatus 200 may further comprise a memory and/or storage 270. Memory/storage 270 may be connected to controller 210. Memory/storage 270 may include an application module 275. The application module 275 may comprise other hardware and/or software applications of apparatus 200. The memory/storage 270 may also incorporate a database 280. The database 280 may comprise one or more data items, for example information related to one or more users of the apparatus 200. The data items may be related to identification information. Memory/storage 270 may further store executable instructions that are configured to cause the apparatus 200 to perform various actions in co-operation with the control module 210.

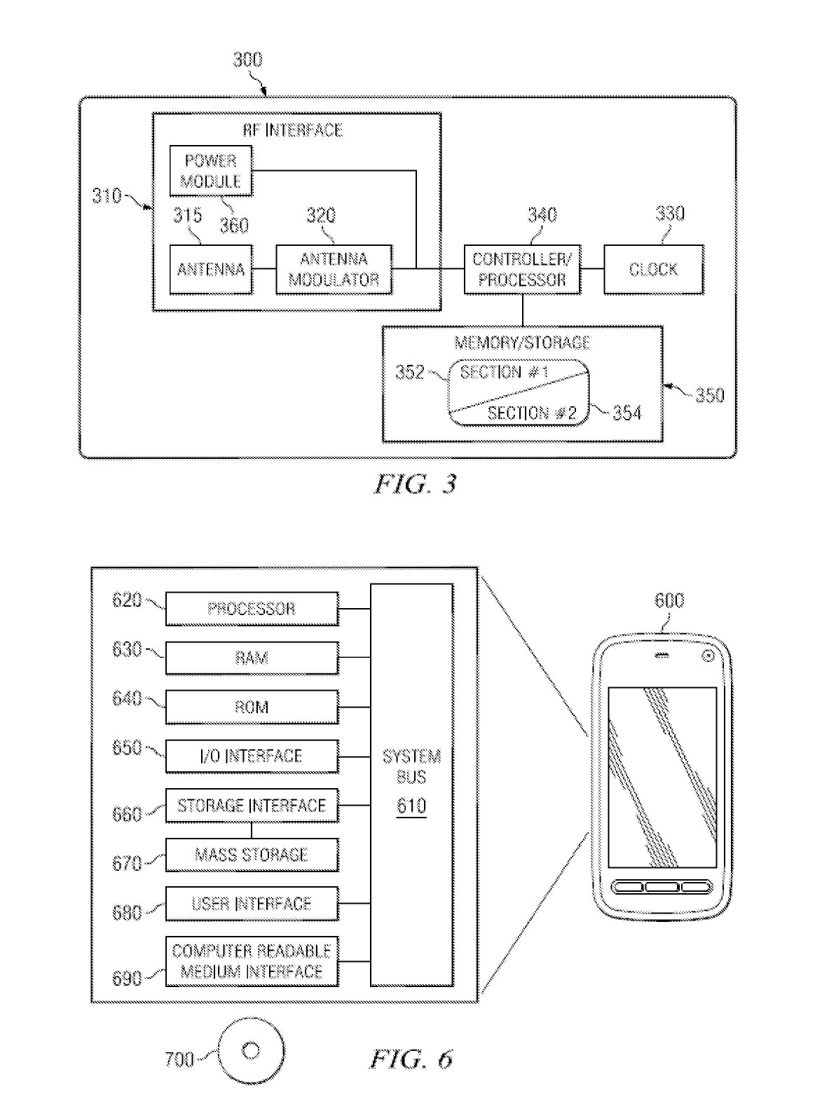

FIG. 3 discloses a modular layout of a device, such as a write-enabled radio frequency tag device 300 according to an example embodiment on the present invention. This example implementation includes an RF interface 310 comprising an antenna 315 and an antenna modulator 320. The example write-enabled radio frequency tag device 300 further includes a clock extraction module 330, a processing module 340, a memory/storage 350 and a power module 360.

Antenna modulator 320 controls one or more properties of antenna 315, such as its impedance. This enables the tag device 300 to reflect and/or absorb reader-initiated transmissions. Such reflections or absorptions may be used to convey information in response to interrogation signals. Antenna modulator 320 may cause such reflections and/or absorptions to occur in response to particular portions of interrogation signals, such as clock pulses.

Power module 360, which may also be included in the RF interface 310, provides power to tag components. For instance, power module 360 may include electronics (such as coil(s), rectifier(s), and/or capacitor(s)) to harvest energy from received electromagnetic transmissions, such as from an interrogation signal composed of a series of pulses. In addition to conveying information, each of these pulses may transfers energy that keeps voltage of the tag device 300 above the tag's minimum required operational voltage. Therefore, the tag device 300 may continually operate without any internal power source until the voltage decays below the minimum required operational voltage.

According to an alternative embodiment, the power module 360 may receive power from transmissions originated by another transmission source. So, instead of receiving operational power through received interrogation signal, the tag device 300 may receive power from an RF powering signal provided for example by RF powering interface 250 of apparatus 200.

According to a further alternative embodiment, the power module 360 may include an internal power source, such as a battery so that the tag device 300 can remain operational (i.e. perform various internal processes such as storing data etc.) without external powering. However, even with internal power source the tag device 300 may still require the external RF field for communication with external devices.

A clock extraction module 330 provides timing information. According to an embodiment the clock extraction module is configured to govern performance of other tag components. For instance, the clock extraction module 330 may control the timing in which antenna modulator 320 varies the impedance of antenna 315. According to an embodiment the clock extraction module 330 is configured to provide time stamps, e.g. to any received or transmitted packets or signals.

Processing module 340 controls device operation. As shown in FIG. 3, processing module 340 is coupled to an associated memory, such as memory/storage 350. Processing module 340 may be embodied as a controlling means, for example as a controlling circuitry or one or more microprocessors that are each capable of executing software instructions stored in memory/storage 350.

Memory/storage 350 stores information in the form of data and software components (also referred to herein as modules). This data includes information for transmission to readers, such as a tag identification information and tag data. These software components include instructions that can be executed by processing module 340. Various types of software components may be stored in memory/storage 350. For instance, memory/storage 350 may store software components that control the generation of tag data. Memory/storage 350 may be implemented with random access memory (RAM), read only memory (ROM), Flash memory and/or phase change memory (PCM), or like.

According to an example embodiment of FIG. 3, the memory/storage 350 includes further at least one memory module, embodied for example either as a Flash, or PCM memory module having at least two sections, including memory section #1 352 and memory section #2 354. Memory section #1 352 is dedicated for storing one bit of data in each memory cell, so memory section #1 352 comprises a single-level cell (SLC) memory. Memory section #2 354, on the other hand is dedicated for storing two or more bits of data in each memory cell, so memory section #2 354 comprises a multi-level cell (MLC) memory.

According to one embodiment, the memory/storage 350 may comprise either separated or predefined memory sections for SLC and MLC memories so that a portion of the memory/storage is fixed for specific data storing. Alternatively, the memory/storage 350 may comprise a memory that can be dynamically allocated to SLC and MLC based on the current needs for storing data.

When considering various write-enabled devices, such as the write-enabled radio frequency tag device 300 of FIG. 3, the capacity of the memory suitable for storing data becomes important. The more data the device is capable of storing, the more suitable the device is for various data storing actions. As mentioned above, SLC memory is capable of storing only one bit of data in each memory cell, so the storage capacity of SLC memory is smaller than of MLC memory. So, from storage capacity point of view MLC memory may be preferred for writing data into a device, such as the write-enabled radio frequency tag device 300, over SLC.

However, when communicating with passive devices, a reader/writer device, such as apparatus 200, have to provide necessary power for the passive device, such as the write-enabled radio frequency tag device 300 to operate and communicate with the reader/writer device. So, the power consumption of the passive device may result as increased power consumption of the reader/writer device. In a battery powered device, such as apparatus 200, energy consumption is an important topic to consider in connection with operating times, which depends on the current required for operating the device and available battery capacity. So, the higher the energy consumption of apparatus 200 is, the smaller the battery lifetime is for the same device. SLC memory has the advantage of lower power consumption and faster speed in write operation over MLC memory. So, from energy consumption point of view SLC memory may be preferred for writing data to a device, such as the write-enabled radio frequency tag device 300, over MLC.

In view of the above discussion, when writing data to a memory associated with a passive write-enabled device, such as the write-enabled radio frequency tag device 300, there are tradeoffs that need to be considered in terms of storage density and power consumption especially from the perspective of user experience of a reader/writer apparatus, such as apparatus 200. As an example, when a device writing data for example to the memory/storage 350 of the write-enabled radio frequency tag device 300, belongs to a party hosting the write-enabled radio frequency tag device 300 (i.e. a party providing the write-enabled radio frequency tag device 300 and/or responsible for maintaining general content on the write-enabled radio frequency tag device 300) one important characteristic may relate to the available memory size. On the other hand, when a device writing data for example into the memory/storage 350 of the write-enabled radio frequency tag device 300, belongs to a party that is not hosting the write-enabled radio frequency tag device 300 (i.e. any other device by-passing the write-enabled radio frequency tag device 300 with a need to write data into the memory/storage 350 of the write-enabled radio frequency tag device 300) one important characteristic may relate to the required energy consumption and/or to speed of the write operation.

According to an embodiment of the present invention, to provide means for enhanced user experience in connection with data storing into write-enabled devices, such as the write-enabled radio frequency tag device 300, at least two different operation modes for write operation are provided.

A host operation mode comprising a protocol configured to write data to a write-enabled device, such as the write-enabled radio frequency tag device 300, may be selected for example to ensure optimal storage density at the write-enabled radio frequency tag device 300 by instructing the write-enabled radio frequency tag device 300 to store received data e.g. into a memory section #2 354 dedicated for storing two or more bits of data in each memory cell comprising a multi-level cell (MLC) memory. According to one embodiment, when a reader/writer device, such as apparatus 200 transmits data to a write-enabled passive device for writing according to the host operation mode, the transmitted data is associated with an indication associated with the host operation mode. According to one embodiment, the host mode operation indication may be added to the data by a dedicated inserter module operating for example under control, or in connection with control module 210 of the reader/writer apparatus 200. Upon receiving the data including the host operation mode indication, the passive write-enabled device, such as the write-enabled radio frequency tag device 300, is aware that the received data is to be stored into a memory section dedicated for MLC, such as the memory section #2 354 of FIG. 3.

A visitor operation mode comprising a protocol configured to write data to a write-enabled device, such as the write-enabled radio frequency tag device 300, may be selected for example to ensure optimal write speed and/or power consumption for the reader/writer device, such as the apparatus 200, when writing data into the write-enabled radio frequency tag device 300. Data to be written into the write-enabled radio frequency tag device 300 may be associated with an indication for the write-enabled radio frequency tag device 300 to store received data e.g. into a memory section #1 352 dedicated for storing one data bit in each memory cell comprising a single-level cell (SLC) memory. According to one embodiment, when a reader/writer device, such as apparatus 200 transmits data to a write-enabled device for writing according to the visitor operation mode, the transmitted data is associated with an indication associated with the visitor operation mode. According to one embodiment, the visitor operation mode indication may be added to the data by a dedicated inserter module operating for example under control, or in connection with control module 210 of the reader/writer apparatus 200. Upon receiving the data including the visitor operation mode indication, the passive write-enabled device, such as the write-enabled radio frequency tag device 300, is aware that the received data is to be stored into a memory section dedicated for SLC, such as the memory section #1 352 of FIG. 3.

It should be noted that there might be also other operation modes in addition or instead of the host and visitor operation modes. Only data associated with the host operation is stored into a memory section dedicated for MLC according to one embodiment of the present invention.

Further, according to one embodiment of the present invention, if received data includes no indication of the operation mode, a passive write enabled device, such as the write-enabled radio frequency tag device 300 considers the operation mode as a non-host operation mode and stores the received data into a memory section dedicated for SLC according to the visitor operation mode.

Although FIG. 1 discloses two separate entities, namely apparatus 200 and write-enabled radio frequency tag device 300, the write-enabled radio frequency tag 300 may be integrated into the apparatus 200 as a functional part according to one embodiment of the present invention. Accordingly, the tag 300 may be capable of storing data into an associated memory according to a selected operation mode associated with a corresponding indication. This embodiment may be useful for example in connection with flashing operation where the apparatus 200 can be wirelessly flashed via the interface provided by the write-enabled radio frequency tag 300 when data stored in the memory/storage 350 associated with the tag 300 is accessible for example to control module 210 of apparatus 200 via internal connections. After processing, suitable parts of data stored in the memory/storage 350 associated with the tag 300 may be stored in the memory/storage 270 of the apparatus 200.

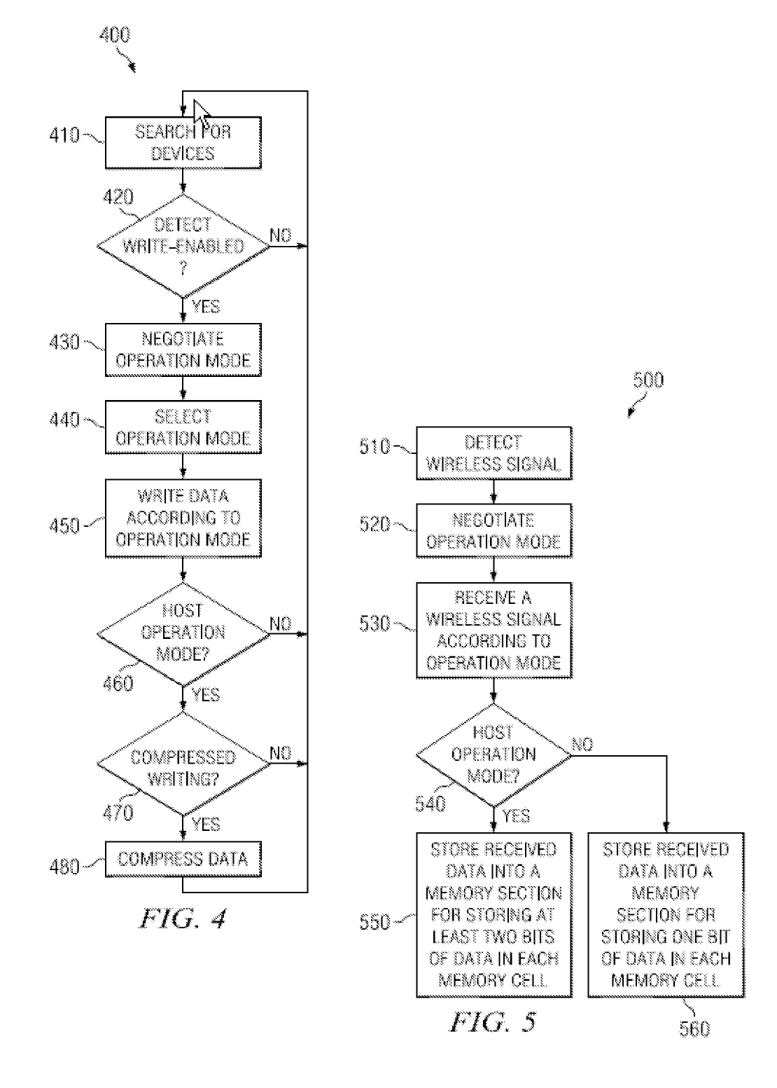

FIG. 4 illustrates a method 400 for information storing according to an example embodiment of the present invention. The method starts with block 410 where an apparatus, such as the reader/writer device 200 of FIG. 1 with a need to write specific data to a write-enabled radio frequency tag, transmits one or more wireless signals in order to search for radio frequency devices, such as the write-enabled tag device 300 of FIG. 1. The wireless signals comprise, according to an embodiment of the present invention, an RF interrogation signal that may provide necessary energy for the tag device to respond to the interrogation signal. According to one embodiment, the interrogation signal energizes the tag device.

In response to the transmitted signals, the apparatus may receive one or more wireless signals that can be used for detecting external devices, as shown in block 420. In case no write-enabled tag devices are detected, the method goes directly back to block 410 and continues with searching for radio frequency devices. According to one embodiment, the operation may be periodical so that a predetermined delay is implemented before entering back to block 410. In case at least one detected device comprises a write-enabled tag, the method may continue with block 430 that can be considered as optional block according to some embodiments of the present invention. In block 430 the apparatus negotiates with the detected write-enabled tag device an operation mode to write data to a memory associated with the write-enabled tag device. The negotiation of the operation mode for write operation may comprise exchanging one or more signals with the tag. The operation mode to write data to the memory associated with the write-enabled tag device is selected in block 440. According to one embodiment the operation mode comprises a protocol for writing data to the write-enabled tag device, wherein the protocol may comprise exchange of one or more signals including data and an operation mode indication associated with the data. According to one embodiment, the method 400 proceeds straight from block 420 to 440.

After selection of the operation mode to write data to the memory associated with the write-enabled tag device in block 440, the method continues with block 450 where the apparatus is configured to perform the write operation according to the selected operation mode. According to an embodiment, the write operation mode comprises communicating with the write-enabled tag device according to the protocol for writing data to the write-enabled tag device, wherein the protocol may comprise exchange of one or more signals including data and an operation mode indication associated with the data. According to an embodiment of the present invention, selectable operation modes comprise at least a host mode and a visitor mode. Irrespective of the operation mode to write data to the memory associated with the write-enabled radio frequency tag, the write operation comprises transmitting the specific data to the write-enabled tag device with an indication associated with the selected operation mode. Upon receiving the transmitted data and the indication associated with the selected operation mode, the write-enabled tag device may store the received data to an associated memory of the write-enabled tag device according to the selected operation mode.

The method 400 continues with optional decision block of 460, where the selected operation mode is checked, and in case the selected operation mode comprises the host operation mode, the method may continue with optional decision block 470. If the selected operation mode does not comprise host mode, the method goes back to block 410 and continues with searching for radio frequency devices. In the optional decision block 470, the apparatus, such as the reader/writer device 200 of FIG. 1 determines whether the associated memory of the write-enabled tag device includes data sectors requiring compressed writing according to the host mode. According to an embodiment of the present invention, the decision block 470 comprises negotiating with the write-enabled tag device whether the memory associated with the write-enabled tag device includes data sectors requiring compressed writing according to the host mode. If the decision block 470 indicates that the memory associated with the write-enabled tag device does not include data sectors requiring compressed writing, the method goes back to block 410 and continues with searching for radio frequency devices. If the decision block 470 indicates that the memory associated with the write-enabled tag includes data sectors requiring compressed writing that the reader/writer apparatus is willing to write into the write-enabled tag device with a compressed format according to the host operation mode, the method continues with optional block 480 where the apparatus performs a write operation for compressing at least a portion of data stored in the memory associated with the write-enabled tag device in the write-enabled tag device according to the host operation mode. After optional block 480, the method goes back to block 410 and continues with searching for radio frequency devices.

FIG. 5 illustrates a method 500 for information storing according to an example embodiment of the present invention. The method may start with an optional block 510 where an apparatus, such as the write-enabled tag device 300 of FIG. 1 detects a wireless signal providing power to the tag device. After receiving the wireless signal of block 510, the method 500 may continue with a further optional block 520 where the write-enabled tag device negotiates with an apparatus, such as the reader/writer device 200 of FIG. 1 an operation mode to write data to a memory associated with the write-enabled tag device. The negotiation of the operation mode for write operation may comprise exchanging one or more signals with the reader/writer apparatus. The method 500 continues with block 530 where the write-enabled tag device receives one or more wireless signals including payload data for writing into a memory associated with the write-enabled tag device according to a protocol configured to write data into the write-enabled device according to an operation mode. According to one embodiment, the received one or more wireless signals may include an indication associated with the operation mode so that the write-enabled tag device is capable of storing the received data to the associated memory of the write-enabled tag device according to the operation mode.

The method 500 continues with decision block 540, where it is determined whether the received indication corresponds with a host operation mode. According to one embodiment, if the indication corresponds with host operation mode, the received payload data is stored in a memory section of an associated memory suitable for storing at least two bits of data in each memory cell of the associated memory as shown in block. In case the indication does not correspond to the host operation mode, such as visitor operation mode, the received payload data is stored in a memory section of an associated memory suitable for storing one data bit in each memory cell of the associated memory as shown in block 560. According to one embodiment, if no operation mode indication is received, the received payload data is stored in a memory section of an associated memory suitable for storing one data bit in each memory cell of the associated memory as shown in block 560. According to one embodiment of the present invention, both of the memory sections are suitable for storing at least two bits of data in each memory cell of the associated memory and the relative proportions of the memory sections are adjustable according to current need.

According to an embodiment of the present invention, a write-enabled tag device, such as the write-enabled radio frequency tag device 300, may negotiate with a reader/writer apparatus after the initial data writing operation whether the reader/writer apparatus, such as the apparatus 200, is co-operative to participate in writing at least a portion of the data sectors within a memory associated with the write-enabled tag device in a compressed manner according to host operation mode where two or more bits of data is stored in each memory cell of the memory associated with the write-enabled tag device. If the negotiation results in compression operation, the write-enabled tag device may store the corresponding data sectors within the associated memory according to the host operation mode.

Without in any way limiting the scope, interpretation, or application of the claims appearing below, a technical effect of one or more of the example embodiments disclosed herein may be enhanced user experience in connection with data storing into write-enabled devices, such as the write-enabled radio frequency tag device 300. Another technical effect may be providing at least two different operation modes for write operation. Yet another technical effect may be providing optimal data storing depending on the needs of the reader/writer apparatus, such as apparatus 200.

Various operations and/or the like described herein may be executed by and/or with the help of computers. Further, for example, devices described herein may be and/or may incorporate computers. The phrases “computer”, “general purpose computer”, and the like, as used herein, refer but are not limited to a media device, a personal computer, an engineering workstation, a personal digital assistant, a portable computer, a computerized watch, a wired or wireless terminal, phone, node, and/or the like, a set-top box, a personal video recorder (PVR), an automatic teller machine (ATM), a game console, and/or the like.

Embodiments of the present invention may be implemented in software, hardware, application logic or a combination of software, hardware and application logic. The software, application logic and/or hardware may reside on a memory of either of apparatuses 200 and 300 of FIG. 1. In an example embodiment, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that may contain or store the instructions for use by or in connection with an instruction execution system, apparatus, or device, such as a computer.

The phrases “general purpose computer”, “computer”, and the like may also refer to one or more processors operatively connected to one or more memory or storage units, wherein the memory or storage may contain data, algorithms, and/or program code, and the processor or processors may execute the program code and/or manipulate the program code, data, and/or algorithms. Accordingly, example computer 600 as shown in FIG. 6 that may be considered as one embodiment of the apparatuses 200 and 300 illustrated on FIG. 1 may include various hardware modules for causing the computer to implement one or more embodiments of the present invention. According to one example, the computer 600 include a system bus 610 which may operatively connect processor 620, random access memory 630, read-only memory 640 that may store for example a computer code for the computer 600 to perform the example methods illustrated on FIGS. 4 and 5. The system bus 610 may further operatively connect input output (I/O) interface 650, storage interface 660, user interface 680 and computer readable medium interface 690. Storage interface 660 may comprise or be connected to mass storage 670.

Mass storage 670 may be a hard drive, optical drive, or the like. Processor 620 may comprise a microcontroller unit (MCU), a digital signal processor (DSP), or any other kind of processor. Computer 600 as shown in this example also comprises a touch screen and keys operating in connection with the user interface 680. In various example embodiments, a mouse, and/or a keypad may alternately or additionally be employed. Computer 600 may additionally include the computer readable medium interface 680, which may be embodied by a card reader, a DVD drive, a floppy disk drive, and/or the like. Thus, media containing program code, for example for performing method 500 of FIG. 5, may be inserted for the purpose of loading the code onto the computer.

Computer 600 may run one or more software modules designed to perform one or more of the above-described operations. Corresponding program code may be stored on a physical media 700 such as, for example, DVD, CD-ROM, and/or floppy disk. It is noted that any described division of operations among particular software modules is for purposes of illustration, and that alternate divisions of operation may be employed. Accordingly, any operations discussed as being performed by a software module may instead be performed by a plurality of software modules. Similarly, any operations discussed as being performed by a plurality of modules may instead be performed by a single module. It is noted that operations disclosed as being performed by a particular computer may instead be performed by a plurality of computers.

According to one embodiment, a computer program product is provided, the computer program product comprising computer executable program code recorded on a computer readable storage medium, the computer executable program code comprising: A code for detecting a write-enabled device; a code for selecting an operation mode comprising a protocol configured to write data the write-enabled device, and a code for transmitting data to the write-enabled radio device according to the selected operation mode.

According to one embodiment, a computer program product is provided, the computer program product comprising computer executable program code recorded on a computer readable storage medium, the computer executable program code comprising: In response to receiving a wireless signal, the wireless signal comprising data and a protocol configured to write the data into a write-enabled device according to an operation mode, a code for storing the received data in an associated memory/storage, the associated memory/storage comprising at least two memory sections; wherein the operation mode determines a memory section of the at least two memory sections to which the received data is stored.

According to one embodiment, an apparatus is provided, the apparatus comprising: A short-range communications module configured to detect a write-enabled device; and a processor configured to select an operation mode comprising a protocol configured to write data to the write-enabled device; wherein the short-range communications module is further configured to transmit data to the memory associated with the write-enabled device according to the selected operation mode.

According to one embodiment, an apparatus is provided, the apparatus comprising: A short-range communications interface configured to receive a wireless signal, the wireless signal comprising data and a protocol configured to write the data into a write-enabled device according to an operation mode. The apparatus further comprising an associated memory/storage configured to store the received data, the associated memory/storage comprising at least two memory sections; wherein the operation mode determines a memory section of the at least two memory sections to which the data received data is stored.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
detecting a write-enabled device;
selecting an operation mode comprising a protocol configured to write data to the write-enabled device; and
transmitting data and an associated operation mode indication to the write-enabled device according to the selected operation mode.

2. A method according to claim 1, further comprising exchanging negotiation messages with the write-enabled device before selecting the operation mode.

3. A method according to claim 1, wherein the selected operation mode comprises instructing the write-enabled device to write two or more bits of data in each memory cell of the write-enabled device.

4. A method according to claim 1, wherein the selected operation mode comprises instructing the write-enabled device to write one bit of data in each memory cell of the write-enabled device.

5-17. (canceled)

18. A method, comprising:
receiving a wireless signal, the wireless signal comprising data and an associated operation mode indication identifying a protocol configured to write the data into a write-enabled device according to the operation mode; and storing the received data into an associated memory, the associated memory comprising at least two memory sections;
wherein the operation mode determines a memory section of the at least two memory sections to which the received data is stored.

19. A method according to claim 18, further comprising exchanging negotiation messages before storing the received data into the associated memory.

20. A method according to claim 18, wherein the at least two memory sections comprise a first memory section configured to store one bit of data in each memory cell of the associated memory and a second memory section configured to store at least two bits of data in each memory cell of the associated memory.

21. (canceled)

22. The method according to claim 18, wherein the received data is stored into a first memory section for storing one bit of data in each memory cell of the associated memory unless the operation mode indication is associated with storing data into a second memory section for storing at least two bits of data in each memory cell of the associated memory.

23-32. (canceled)

33. An apparatus, comprising:
a short-range communications module configured to detect a write-enabled device; and a processor configured to select an operation mode comprising a protocol configured to write data to the write-enabled device;
wherein the short-range communications module is further configured to transmit data and an associated operation mode indication to the write-enabled device according to the selected operation mode.

34. An apparatus according to claim 33, wherein the short-range communications module is further configured to exchange negotiation messages with the write-enabled device before selection of the operation mode.

35. An apparatus according to claim 33, wherein the short-range communications module is further configured to write two or more bits of data in each memory cell of the write-enabled device.

36. An apparatus according to claim 33, wherein the short-range communications module is further configured to write one bit of data in each memory cell of the write-enabled device.

37-38. (canceled)

39. An apparatus according to claim 33, further comprising an RF powering interface configured to generate a radio frequency field to wirelessly power the write-enabled device.

40. A computer program product comprising computer executable program code recorded on a computer readable storage medium, the computer executable program code comprising:
code for causing detection of a write-enabled device;
code for selecting an operation mode comprising a protocol configured to write data to the write-enabled device; and
code for causing transmission of data and an associated operation mode indication to the write-enabled radio device according to the selected operation mode.

41-45. (canceled)

46. An apparatus, comprising:
a short-range communications module configured to receive a wireless signal, the wireless comprising data and an operation mode indication identifying a protocol configured to write the data into a write-enabled device according to an operation mode; and
a memory configured to store the received data, the memory comprising at least two memory sections;
wherein the operation mode determines a memory section of the at least two memory sections to which the data received data is stored.

47. An apparatus according to claim 46, wherein the short-range communications module is further configured to negotiate the operation mode before storing the receiving data.

48. An apparatus according to claim 46, wherein the at least two memory sections comprise a first memory section configured to store one bit of data in each memory cell and a second memory section configured to store at least two bits of data in each memory cell.

49. (canceled)

50. An apparatus according to claim 46, wherein the received data is configured to be stored into a first memory section configured to store one bit of data in each memory cell of the associated memory unless the operation mode indication is associated with storing data into a second memory section configured to store at least two bits of data in each memory cell of the associated memory.

51. An apparatus according to claim 46, further comprising a power module configured to receive power from an external radio frequency signal.

52. A computer program product comprising computer executable program code recorded on a computer readable storage medium, the computer executable program code comprising:
code configured for causing receiving of a wireless signal, the wireless signal comprising data and an associated operation mode indication identifying a protocol configured to write the data into a write-enabled device according to the operation mode; and
code for causing storing of the received data in an associated memory, the associated memory comprising at least two memory sections;
wherein the operation mode indication determines a memory section of the at least two memory sections to which the received data is stored.

53-58. (canceled)
